(19) United States
(12) Patent Application Publication
(10) Pub. No.: US 2014/0123538 A1
(43) Pub. Date: May 8, 2014

(54) DEER COMMUNICATION SITE

(71) Applicant: SCOTT MATHESON, PLYMOUTH, WI (US)

(72) Inventor: SCOTT MATHESON, PLYMOUTH, WI (US)

(21) Appl. No.: 14/070,330

(22) Filed: Nov. 1, 2013

Related U.S. Application Data
(60) Provisional application No. 61/721,696, filed on Nov. 2, 2012.

(51) Int. Cl. A01M 31/06; F16M 13/02

(52) U.S. Cl. CPC A01M 31/06; F16M 13/02
USPC 43/2

(57) ABSTRACT

A deer communication site for the purposes of attracting and keeping deer in a general location by providing a generally horizontal support rod projected out from a generally vertical support at deer head height and a flexible mounting for a licking branch that allows the licking branch to hang down from the support rod and is flexible to allow swinging motion with a means to attach a scent dispersing device adjacent to the licking branch.

### CROSS-REFERENCE TO RELATED APPLICATIONS

This application claims the benefit of U.S. Provisional Application 61/721,696 filed Nov. 2, 2012.

### BACKGROUND OF THE INVENTION

1. Field of the Invention

This invention generally relates to creating a communication site for cervidae, i.e., deer, more specifically it pertains to a device to hang and simulate a branch used by deer for communication that can be mounted in any location.

2. Description of the Related Art

It has been long known by persons interested in deer, e.g., hunters, photographers, conservationists, etc., that deer communicate with scent throughout the year which intensifies during the mating season. Does in heat can let the bucks in the area know they are in season via leaving scent in specific areas with the bucks replying in the form of scrapes on the ground and rubbings on the trunk of trees. Up until recently the majority of focus on the communication location for mating has been scrapes on the ground with limited knowledge as to why they would appear in the same spot for up to several years at a time and then suddenly vanish for no apparent reason.

More recently it has been discovered that the scrapes are in relation to a broken but still hanging end of a branch on a tree in the immediate area. This broken portion of the branch is at the general height of the head of the deer, hanging down for the deer to use its saliva and preorbital glands on, and that is of the right texture and taste for a deer to utilize. This end portion of the branch that is broken but still hanging will be referred to hereafter as a licking branch.

The licking branch has been found to play a vital role in communication for deer all year long, not just during the rutting season. Both male and female deer use it for daily communication to let the others know who is in the general area. It is thought that because the licking branch is hanging at the end of the protruding branch and is able to sway to and fro that the deer are visually attracted to it and its motion first prior to using it. It also makes it easier for the deer of multiple heights to leave their respective scent on the licking branch.

A problem facing these communication locations is that they are generally adjacent to fields at the tree line facing the field itself. Because the licking branches are at deer head height, they are also in the way of farm equipment. A farmer will remove the entire tree limb along with the licking branch to gain access to the ground to increase the crop yield of the field. The elimination of the licking branch results in the cessation of deer communication activities within the area immediately and subsequently breeding opportunities. The adding of roads through wooded areas for human development and urban growth can also cause these communication sites to be eliminated.

Another issue with these communication sites is the seasonal variation of the fruits, seeds, nuts and foliage that can change the height of the licking branch due to their weight on the branch. The additional leaves, fruits, nuts, and seeds in late spring through summer can lower the licking branch and then raise the branch as they drop it in autumn. This can make the communication site become too seasonal depending on when the licking branch is at the optimum height.

Yet another issue with the naturally occurring licking branch is that the licking branch is the end part of a branch sticking out far enough for the deer to use, but being that it has broken off the main limb such that it is still hanging, the fibers that connect the two branches eventually dry out, become brittle and the licking branch breaks off ending the communication site and mating opportunities.

One attempt to solve the problem of creating a deer communication site is outlined in US Patent Application Publication 2011/0139949 by Todd Duerr which discloses a “V” shaped device to attach foliage to, generally in the form of a branch or tree to replace lost branches to create an overhang. Unfortunately this device does not address the licking branch portion of the foliage that must hang down from the branch at the unsupported end to create the correct communication site.

### BRIEF SUMMARY OF THE INVENTION

The present invention includes a deer communication site for the purposes of attracting and keeping deer in a general location by providing a generally horizontal support rod projected out from a generally vertical support at deer head height and a flexible mounting for a licking branch that allows the licking branch to hang down from the support rod and is flexible to allow swinging motion with a means to attach a scent dispersing device adjacent to the licking branch.

### BRIEF DESCRIPTION OF THE SEVERAL VIEWS OF THE DRAWINGS

FIG. 1 is an overall view of the communication site system.

FIG. 2 is detailed view of the limb splint.

### DETAILED DESCRIPTION OF THE INVENTION

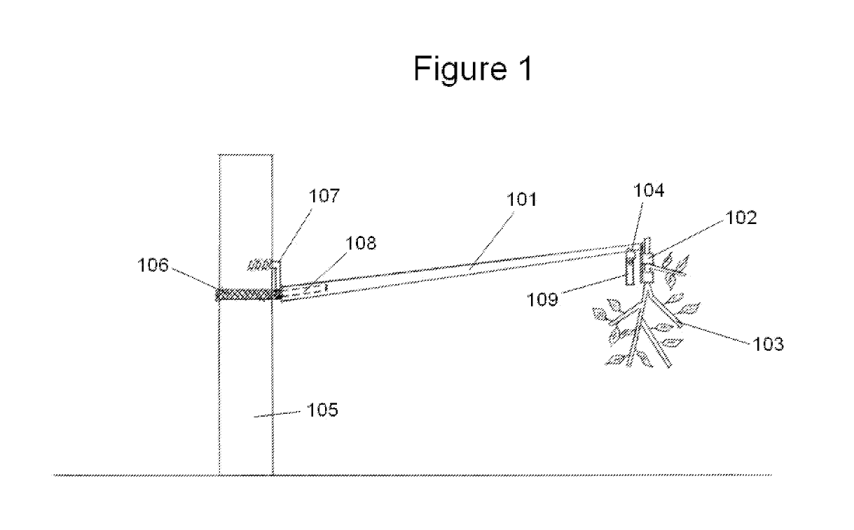

The object of the present invention is to create a deer communication site for the purposes of attracting and keeping deer in a general location for the purposes of observation or hunting. Referring to FIG. 1, the present invention accomplishes the creation of the communication site by providing a generally horizontal elongated rod like support rod 101 at the appropriate deer head height projected out from a generally vertical support 105 with a durable and flexible licking branch mount 102 for licking branch 103 to be attached to the support rod 101. This flexible licking branch mount 102, referred hereafter as a limb splint, used to mount the licking branch 103 to the support rod 101 allows the licking branch 103 to hang down from the support rod 101 and is flexible to allow for wear and free motion.

Vertical support 105 can be made of any appropriate material to support the weight of the deer communication site components and have a height tall enough to mount support rod 101 such that licking branch 103 is approximately at deer head height. Vertical support 105 could be any number of materials or configurations including, but not limited to, the trunk of an existing tree, a wooden telephone pole, a metal post driven into the ground, etc. The preferred embodiment of this invention will consider the material of vertical support 105 to be wood.

A screw in tree step 107 is used to mount support rod 101 to the vertical support 105. The screw in tree step 107 is commonly used by hunters to climb trees and is a metal rod threaded at one end with an offset round protrusion at the other end to form the step. This allows for the tree step 107 to be easily imbedded into vertical support 105 with a portion of it protruding out from the surface of vertical support 105 that can be used for mounting support rod 101. Support rod 101 has a hollow round base 108 to slide over the step end of the screw in tree step 107. It should be noted that while the preferred embodiment of this invention uses a screw in tree step 107, any protuberance from the vertical support 105 that fits into hollow round based 108 of support rod 101 can be used as long as the protuberance can support the weight of the system and is at an appropriate height.

Support rod connecting strap 106 is attached to support rod 101 and wraps around the vertical support 105 or tree step 107 to prevent the hollow round base 108 of support rod 101 to slide off the screw in tree step 107 while the system is being used by deer or from being outside in the elements such as high winds. Connecting strap 106 can be secured around vertical support 105 by various means including, but not limited to hook and loop fasteners, snaps, buckles, etc.

While the preferred embodiment of this invention has the connection of the support rod 101 to vertical support 105 via a hollow round base 108 over the screw in tree step 107 secured with support rod connection strap 106, any reasonable means can be used to attach support rod 101 to vertical support 105. For example, the support rod 101 can have a threaded end to directly screw into vertical support 105 which would then not require connection strap 106.

On the end opposite of support rod 101 from the vertical support 105 is attached limb splint 102. The limb splint 102 is a flexible member to secure licking branch 103. Licking branch 103 can be a piece of foliage from a tree, plant or a synthetic piece made to look like a live piece of foliage.

Near the limb splint end of support rod 101 is an optional scent hook 104 used to attach scent device 109. Attaching a scent device 109 to the support rod 101 can help get the communication site started and maintain it throughout the year. This scent device 109 can be of a porous material that can receive any number of various liquid scents.

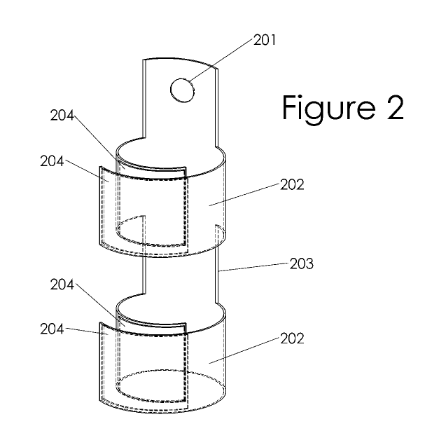

With regard to FIG. 2, limb splint 102 has branch connector flaps 202, made of a flexible material so that it can wrap around an individual branch on the licking branch 103. Hook and loop fasteners 204 provides a means to hold the connector flaps 202 around the licking branch 103. While the preferred embodiment uses hook and loop fasteners, other fasteners including, but not limited to, snaps, d-rings, grommets with wire ties, or any other fastener to hold the connector flap 202 around the licking branch 103 can be used.

Adjacent to the branch connector flap 202 is branch gap 203 that provides a space for a branch on the licking branch 103 to pass through. This allows the for a better connection for the branch connector flap 202 with the hook and loop fastener 204 by not having to wrap around a branch coming off of the main licking branch 103 that is being held by the connector flap 202. While the preferred embodiment of the limb splint 102 has four branch connector flaps 202 that creates one zone on the licking branch 103 that are held by the limb splint 102 with a branch gap 203 between them, there can be any multiple of branch connector flaps 202 with multiple branch gaps 203.

The limb splint 102 is attached to the support rod 101 via the support rod attachment point 201. This attachment in the preferred embodiment is a threaded fastener going through the support rod attachment point 201 into the tip of the support rod 101, however, this could be of various other means including, but not limited to, adhesives, clamps, hook and loop fastener material, etc.

The material of the limb splint 102 in the preferred embodiment is a nylon fabric or synthetic material that provides both durability and flexibility. The hook and loop fastener 204 can also easily be attached to nylon fabric. It should be noted that the limb splint 102 can be made of many other fabric like materials including, but not limited to, leather, flexible plastic films, cotton cloth, to give it the required durability and flexibility or even constructed out of rigid material with hinges.

The limb splint 102 can also be constructed so that in place of the support rod attachment point 201, branch connector flaps 202 with hook and loop fasteners 204 can be used to attached the limb splint to the support rod 101. In the case of an existing branch on a tree that meets the requirements of the support rod 101, i.e., adequate structure and proper height, the limb splint 102 so constructed can be used to create the communication site without the support rod structure.

I claim:

1. A device for creating a deer communication site comprising of an elongated rod-like member, a means on one end of the elongated rod-like member to be mounted to a generally vertical support such that the elongated rod-like member is generally horizonal, and a means on the end opposite of the elongated rod-like member to flexibly mount a licking branch.

2. The device of claim 1 where the means to flexibly mount a licking branch includes a plurality of flaps that wraps around the licking branch to secure it.

3. The device of claim 1 where the means to mount the elongated rod-like member to a generally vertical support comprises a mount that can be imbedded into the generally vertical support with part of the mount protruding out from the surface of the generally vertical support, a hollow feature in the end of the elongated rod-like member that receives the protruding portion of the imbedded mount, and a strap connected to the end of the elongated rod-like member that wraps around the generally vertical support to secure the elongated rod like member.

4. The device of claim 1 further comprising a means to release scent into the atmosphere in the area around device, the means to release scent being located adjacent to the means to flexibly mount for the licking branch.

5. The device of claim 2 where the means to mount the elongated rod-like member to a generally vertical support comprises a mount that can be imbedded into the generally vertical support with part of the mount protruding out from the surface of the generally vertical support, a hollow feature in the end of the elongated rod-like member that receives the protruding portion of the mount, and a strap connected to the end of the elongated rod-like member that wraps around the generally vertical support to secure the elongated rod like member.

6. The device of claim 5 further comprising a means to release scent into the atmosphere in the area around device, the means to release scent being located adjacent to the means to flexibly mount for the licking branch.

7. A deer communication site comprising a generally vertical support, a generally horizontal elongated rod-like member mounted to the generally vertical support, and a licking branch flexibly mounted to the elongated rod-like member on the end opposite from the vertical support.

8. The deer communication site of claim 7 further comprising a mount imbedded into the generally vertical support with a portion of the mount protruding out from the surface of the generally vertical support, a hollow feature in the end of the elongated rod-like member that receives the protruding portion of the imbedded mount, and a strap connected to the end of the elongated rod-like member that wraps around the generally vertical support to secure the elongated rod-like member. mount, and a strap connected to the end of the elongated rod-like member that wraps around the generally vertical support to secure the elongated rod-like member.

9. The deer communication site of claim 7 further comprising a plurality of flaps on the flexible licking branch mount that wrap around the licking branch to secure it.

10. The deer communication site of claim 8 further comprising a plurality of flaps on the flexible licking branch mount what wrap around the licking branch to secure it.

11. The deer communication site of 7 further comprising a scent releasing device mounted adjacent to the licking branch.

12. The deer communication site of 10 further comprising a scent releasing device mounted adjacent to the licking branch.

13. A method of creating a deer communication site comprising the steps of imbedding a mount into a generally vertical support, generally horizontally mounting an elongated rod-like member to the imbedded mount, flexibly mounting a licking branch to the elongated rod-like member on the end opposite from the generally vertical support.

14. The method of creating a deer communication site of claim 13 further comprising leaving a portion of the imbedded mount protruding out from the surface of the generally vertical support, placing a hollow feature in the end of the elongated rod-like member over the protruding portion of the imbedded mount, wrapping a strap connected to the elongated rod-like member around the generally vertical support to secure the elongated rod like member to the generally vertical support.

15. The method of creating a deer communication site of claim 13 further comprising wrapping flaps on the flexible licking branch mount around the licking branch to flexibly secure it.

16. The method of creating a deer communication site of claim 14 further comprising wrapping flaps on the flexible licking branch mount around the licking branch to flexibly secure it.

17. The method of creating a deer communication site of claim 13 further comprising attaching a scent producing device adjacent to the licking branch.

18. The method of creating a deer communication site of claim 16 further comprising attaching a scent producing device adjacent to the licking branch.
